(19) United States
(12) Patent Application Publication
(10) Pub. No.: US 2012/0025582 A1
(43) Pub. Date: Feb. 2, 2012

(54) SEAT ASSEMBLY HAVING AN ADJUSTABLE HEAD RESTRAINT ASSEMBLY

(75) Inventors: Mladen Humer, West Bloomfield, MI (US); Arjun Yetukuri, Rochester Hills, MI (US)

(73) Assignee: LEAR CORPORATION, Southfield, MI (US)

(21) Appl. No.: 13/146,468

(22) PCT Filed: Apr. 23, 2009
(86) PCT No.: PCT/US09/41512

§ 371 Date: Jul. 27, 2011

(51) Int. Cl. B60N 2/48

(52) U.S. Cl. 297/391

(57) ABSTRACT

A seat assembly having a seat back and a head restraint assembly. The head restraint assembly includes a headrest, a support post, and a drive assembly that may have a rotatable element. The drive assembly engages the support post and actuates the headrest away from the seat back when the rotatable element is rotated in a first direction and actuates the headrest toward the seat back when the rotatable element is rotated in a second direction.

### BACKGROUND OF THE INVENTION

### Field of the Invention

The present invention relates to a seat assembly having an adjustable head restraint assembly.

### SUMMARY OF THE INVENTION

In at least one embodiment, a seat assembly is provided. The seat assembly has a seat back and a head restraint assembly. The head restraint assembly includes a headrest for supporting the head of a seat occupant, a support post, and a drive assembly. The support post extends between the seat back and the headrest and has an engagement area. The drive assembly has a rotatable element that engages the engagement area. The drive assembly actuates the headrest away from the seat back when the rotatable element is rotated in a first direction and actuates the headrest toward the seat back when the rotatable element is rotated in a second direction that is opposite the first direction.

In at least one other embodiment, a seat assembly is provided. The seat assembly has a seat back and a head restraint assembly disposed on the seat back. The head restraint assembly includes a support post, a headrest, an armature, and a drive assembly. The support post extends from the seat back and has an engagement area. The headrest is disposed on a support post and is spaced apart from the engagement area. The armature is disposed in the seat back and has an upright member that receives the support post. The upright member has an aperture disposed proximate the engagement area. The drive assembly at least partially extends through the aperture to engage the engagement area. The drive assembly actuates the headrest toward and away from the seat back.

In at least one additional embodiment, a seat assembly is provided that has a seat back and a head restraint assembly. The head restraint assembly has a support post, a headrest, and a drive assembly. The support post is disposed on the seat back and has an engagement area. The headrest is disposed on the support post. The drive assembly has an output unit, an intermediate unit, and an actuator unit. The output unit operatively engages the engagement area. The intermediate unit rotates to actuate the output unit. The actuator unit rotates the intermediate unit. The headrest moves in a first direction when the intermediate unit rotates in a first rotational direction and moves in a second direction disposed opposite the first direction when the intermediate unit rotates in a second rotational direction.

### BRIEF DESCRIPTION OF THE DRAWINGS

FIG. 1 is a perspective view of a seat assembly.

FIG. 2 is a fragmentary perspective view of a portion of a seat back of the seat assembly including an exemplary embodiment of an adjustable head restraint assembly.

FIG. 3 is an exploded perspective view of the adjustable head restraint assembly shown in FIG. 2.

FIG. 4 is a magnified side view of a portion of a support post of the adjustable head restraint assembly.

FIG. 5 is a fragmentary side view of a portion of another embodiment of an adjustable head restraint assembly.

### DETAILED DESCRIPTION

Detailed embodiments of the present invention are disclosed herein; however, it is to be understood that the disclosed embodiments are merely exemplary of the invention that may be embodied in various and alternative forms. The figures are not necessarily to scale, some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the present invention.

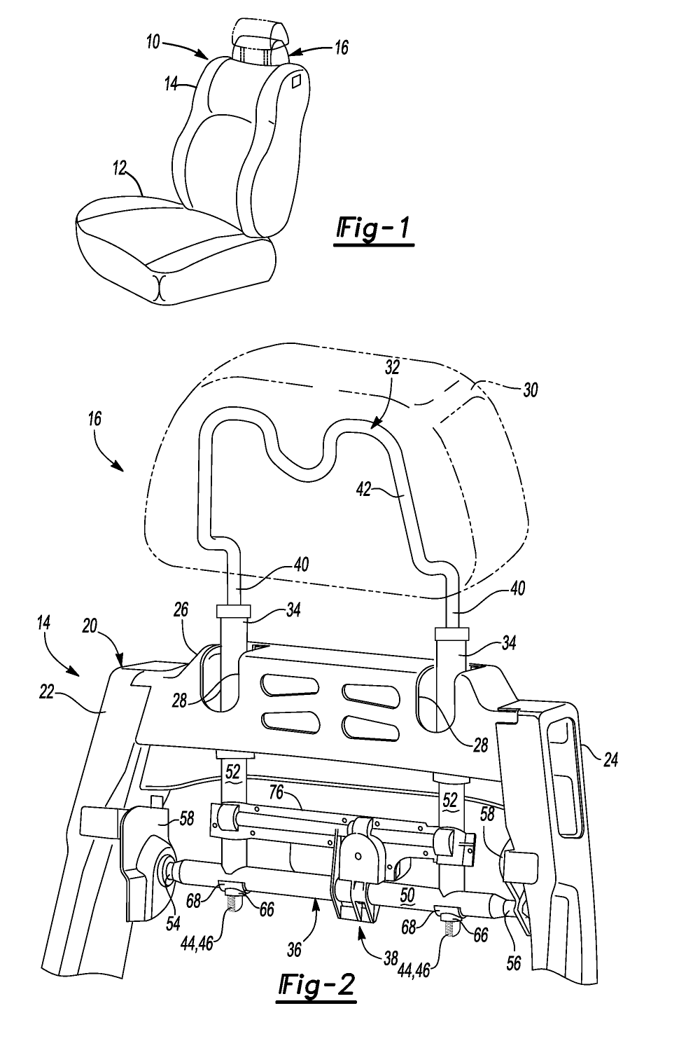

Referring to FIG. 1, an exemplary seat assembly 10 is shown. The seat assembly 10 may be configured for use in a vehicle, such as a motor vehicle like a car or truck.

The seat assembly 10 may include a seat bottom 12 and a seat back 14. The seat bottom 12 may be configured to be mounted on a support surface, such as a floor pan of a vehicle. The seat back 14 may be pivotally disposed on the seat bottom 12 and may include a head restraint assembly 16.

Referring to FIG. 2, an upper portion of the seat back 14 and the head restraint assembly 16 are shown in more detail. The seat back 14 may include a structural frame 20. The frame 20 may include first and second side members 22, 24 and a cross member 26 that extends between the first and second side members 22, 24. Alternatively, the first and/or second side members 22, 24 may be integrally formed with the cross member 26 in one or more embodiments of the present invention. The cross member 26 may include one or more openings 28 that receive a portion of the head restraint assembly 16 as will be discussed in more detail below.

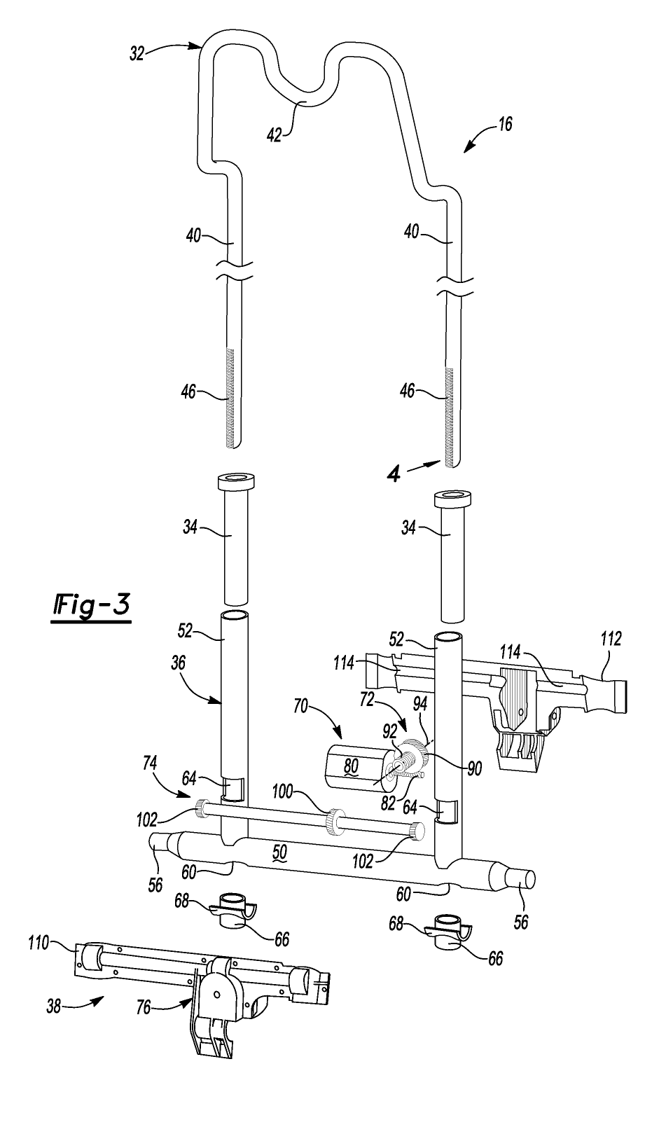

Referring to FIGS. 2 and 3, the head restraint assembly 16 is shown in more detail. The head restraint assembly 16 may be configured to move with respect to the seat back 14. In addition, the head restraint assembly 16 may be used with a seat assembly having an active head restraint system in which a head restraint moves to support the head of a seat occupant in response to a vehicle impact event. An example of such an active head restraint system is described in U.S. Pat. Nos. 6,789,845 and 7,455,357, assigned to the assignee of the present invention and hereby incorporated by reference in its entirety. In at least one embodiment, the head restraint assembly 16 may include a headrest 30, a support post 32, a guide sleeve 34, an armature 36, and a drive assembly 38.

The headrest 30 may be configured to support the head of a seat occupant. The headrest 30 may be disposed above or at the top of the seat back 14 and may be mounted to and disposed around the support post 32. For clarity, the headrest 30 is shown in phantom in FIG. 2 and is not shown in FIG. 3.

The support post 32 may extend between the headrest 30 and the seat back 14. The support post 32 may include one or more upright portions 40 and a headrest mounting portion 42. The upright portions 40 and headrest mounting portion 42 may be provided as a one-piece component and may be made of any suitable material, such as a metal or metal alloy. The upright portions 40 may be generally linear in one or more embodiments.

An engagement area 44 may be provided along at least a portion the support post 32. For example, the engagement area 44 may be provided on at least one upright portion 40. The engagement area 44 may be disposed in any suitable side and location on the upright portion 40. For example, the engagement area 44 may extend from a free end of the upright portion 40 along a portion of the upright portion 40 such that the engagement portion 44 is not visible when the support post 32 is installed in the seat back 14. In an embodiment in which the headrest 30 moves with respect to the support post 32, the engagement area 44 may be provided on the headrest mounting portion 42.

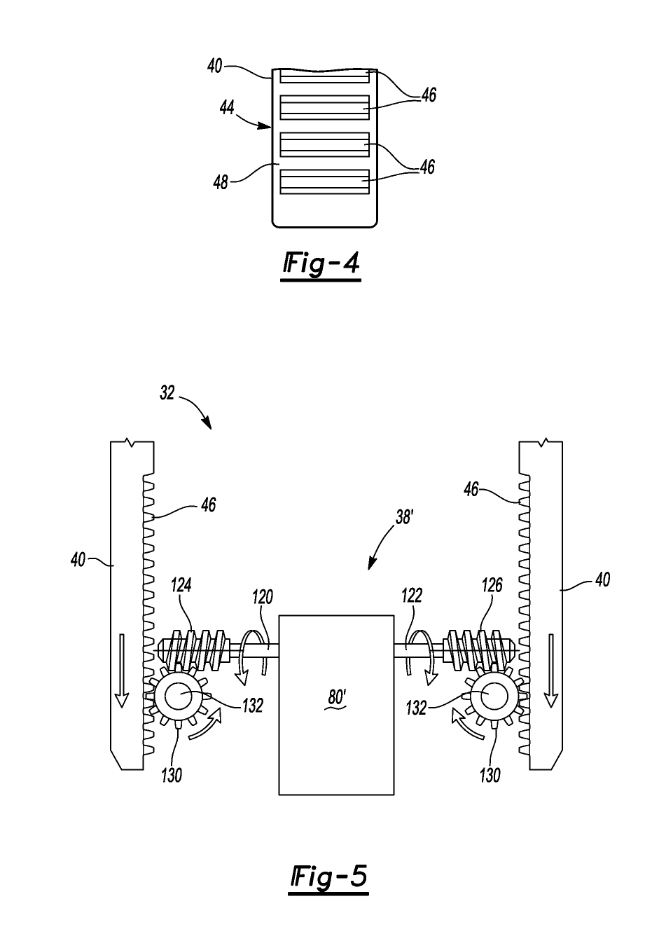

The engagement area 44 may have any suitable configuration. For example, the engagement area 44 may be configured with a surface treatment or features that help provide sufficient friction to facilitate actuation of the support post 32. For instance, the engagement area 44 may be provided with protrusions, indentations, a rough or textured surface, or combinations thereof. In at least one embodiment, the engagement area 44 includes a set of teeth 46. As is best shown in FIG. 4, the set of teeth 46 may be disposed on a surface 48. The surface 48 may have any suitable configuration and may be generally flat or planar. In addition, each member of the set of teeth 46 may extend partially across the surface 48. As such, the teeth may be spaced apart or set back from lateral edges of the surface 48, such as where the surface 48 intersects a curved surface of the support post 32, which may help inhibit binding during installation and/or operation.

The headrest mounting portion 42 may be disposed in the headrest 30. The headrest mounting portion 42 may extend from at least one upright portions 40 and may be configured to help receive and/or distribute force exerted by a head of a seat occupant. The headrest mounting portion 42 may extend between and connect multiple upright portions 40 in embodiments of a support post 32 having more than one upright portion 40. In addition, the headrest mounting portion 42 may extend forward or at an angle from the upright portions 40.

The guide sleeve 34 may receive a portion of the support post 32. In addition, the guide sleeve 34 may be disposed in and/or mounted to the frame 20 of the seat back 14. For example, the guide sleeve 34 may generally extend from the top of the seat back 14 into the seat back 14 and into an opening 28 in the cross member 26. In an embodiment having an active head restraint system, the guide sleeve 34 may move with respect to the frame 20 and opening 28.

The armature 36 may be disposed in the seat back 14. The armature 36 may include a lateral member 50 and one or more upright members 52.

The lateral member 50 may be configured to be mounted on the seat back 14. For example, the lateral member 50 may have first and second ends 54, 56 that may be fixedly or pivotally associated with the seat back frame 20. In the embodiment shown in FIGS. 2 and 3, the first and second ends 54, 56 are received by mounting brackets or links 58 that may be disposed on the frame 20. The lateral member 50 may pivot with respect to the links 58 or the links 58 may pivot with respect to the frame 20 to permit the head restraint assembly 16 to move upward and/or forward in one or more embodiments. Alternatively, links 58 may be deleted and the lateral member 50 may be mounted directly to the frame 20 or another suitable component. The lateral member 50 may be configured as a hollow tube and may include one or more openings 60 through which the support post 32 may extend.

One or more upright members 52 may extend from the lateral member 50. In the embodiment shown in FIGS. 2 and 3, two upright members 52 are provided that are spaced apart and extend generally parallel to each other. Each upright member 52 may be configured as a hollow tube and may engage the guide sleeve 34. For example, an upright member 52 may receive a guide sleeve 34 or vice versa in one or more embodiments. As is best shown in FIG. 3, the upright member 52 may include an aperture 64 that permits access to the support post 32 and the engagement area 44. The aperture 64 may have any suitable configuration and may be disposed in any suitable location.

A guide member 66 may be provided in the lateral and/or upright members 50, 52 to help support and guide movement of the support post 32 within the armature 36. Moreover, the guide member 66 may help inhibit rattling of the support post 32. The guide member 66 may have any suitable configuration and may be configured as a ring or bushing. In the embodiment shown, the guide member 66 extends through the opening in the lateral member 50 and into the upright member 52 without covering the aperture 64. The guide member 66 may include a flange 68 that may engage the lateral member 50 to help position the guide member 66.

The drive assembly 38 may provide force to actuate or initiate movement of the head restraint assembly 16. The drive assembly 38 may actuate at least a portion of the head restraint assembly 16 in multiple directions and between multiple positions. For example, the drive assembly 38 may actuate the head restraint assembly 16 generally toward or away from the seat back 14. Moreover, the drive assembly 38 may actuate the headrest 30 or head restraint assembly 16 between a fully advanced position and a fully retracted position and hold it at one or more positions therebetween.

The drive assembly 38 may have any suitable configuration. As is best shown in FIG. 3, the drive assembly 38 may include an actuator unit 70, an intermediate unit 72, and output unit 74, and a housing 76. The present invention also contemplates embodiments that may omit one or more of these units, such as the intermediate unit 72 and/or output unit 74, or the housing 76.

The drive assembly 38 may be disposed in any suitable location. In the embodiment shown in FIG. 2, the drive assembly 38 is located below the cross member 26 of the seat back frame 20 and generally above the lateral member 50 of the armature 36. Alternatively, the drive assembly 38 may be reconfigured to be located generally below the lateral member 50. In such an embodiment, the aperture 64 in the upright member 52 of the armature 36 may be eliminated. In at least one another embodiment, the drive assembly 38 may be mounted to the frame 20 or located in the cross member 26. In addition, the drive assembly 38 may be disposed in the headrest 30 in one or more embodiments and configured to move with respect to the support posts 32.

The actuator unit 70 may be configured to exert a biasing force. The actuator unit 70 may have any suitable configuration. For example, the actuator unit 70 may include an electrical machine 80, such as a motor or solenoid. The electrical machine 80 may include an output element 82, such as an output shaft that may be adapted to drive or exert force upon the intermediate unit 72. For instance, the output element 82 may be provided with an engagement feature, such as a gear like a worm gear, that engages the intermediate unit 72.

The intermediate unit 72, if provided, may transmit force from the actuator unit 70 to the output unit 74. The intermediate unit 72 may be provided with a unitary construction or as an assembly of components. The intermediate unit 72 may include a first portion 90 and a second portion 92. The first and second portions 90, 92 may be disposed along and/or rotate about a common axis 94. The first portion 90 may be adapted to engage the output element 82 of the actuator unit 70. For instance, the first portion 90 may be configured as a gear such as a helical gear. The second portion 92, which may have a smaller diameter than the first portion 90, may also be configured as gear like as a worm and may be adapted to engage the output unit 74. As such, the intermediate unit 72 may be configured to provide a predetermined amount of gear reduction that may facilitate the use of smaller or less expensive electrical machine.

The output unit 74, if provided, may transmit force from the intermediate unit 72 to actuate the support post 32. The output unit 74 may be provided with a unitary construction or as an assembly of components. The output unit 74 may have any suitable configuration. For instance, the output unit 74 may generally be configured as a shaft and may include an input element 100 and at least one output element 102. The input element 100 may be adapted to engage the second portion 92 of the intermediate unit 72.

The input element 100 may have any suitable configuration. For instance, the input element 100 may be configured as a gear such as a helical gear. The output element 102 may be adapted to engage the engagement area 44 of the support post 32. The output element 102 may have any suitable configuration that is compatible with the engagement area 44. For example, the output element 102 may be configured with a surface treatment or features that help provide sufficient friction to facilitate actuation of the support post 32. For instance, the output element 102 may be provided with protrusions, indentations, a rough or textured surface, or combinations thereof. In at least one embodiment, the output element 102 may be configured as a gear such as a spur gear that engages the set of teeth 46 on the support post 32. The input element 100 may be spaced apart from the output element 102.

The housing 76 may facilitate mounting of the drive assembly 38 and various components. As is best shown in FIG. 2, the housing 76 may be mounted on the armature 36. For example, the housing 76 may be mounted to the lateral member 50 and or an upright member 52. Alternatively, one or more of these mounting positions may be deleted or changed. For instance, the housing 76 could be mounted to one or more different components, such as the frame 20 in one or more embodiments.

The housing 76 may have any suitable configuration. In the embodiment shown, the housing 76 includes a first portion 110 and a second portion 112. The first and second portions 110, 112 may have similar configurations. The first and second portions 110, 112 may cooperate to facilitate mounting of the housing 76. For instance, the first and second portions 110, 112 may be disposed around and fixedly positioned relative to the lateral member 50 and/or upright members 52. Of course, the present invention also contemplates embodiments in which the housing 76 has a different number of attachment points or locations of attachment. For example, the housing 76, if provided, may be coupled to the frame 20 or disposed in the headrest 30 in other embodiments as previously discussed.

The first and second portions 110, 112 may also receive various components of the actuator unit 70, intermediate unit 72, and/or output unit 74. For instance, the actuator unit 70 and intermediate unit 72 may be mounted to and/or at least partially received by the first and second portion 110, 112. The first and second portions 110, 112 may also cooperate to define a channel 114 that receives the output unit 74. As such, the first and second portions 110, 112 may support the output unit 74 in the channel 114 and permit the output unit 74 to rotate. The first and second portions 110, 112 may be made of any suitable material, such as a polymeric material and may be assembled in any suitable manner, such as by fasteners, mating features, a bonding agent, or vibration welding.

Operation of the embodiment shown in FIGS. 2 and 3 may be described as follows. An input signal may be provided to control operation of the electrical machine 80 in any suitable manner, such as by a switch that may be disposed on the seat assembly 10 or a controller. The input signal may be indicative of a command to advance or retract the head restraint assembly 16. Advancing the head restraint assembly 16 may move the headrest 30 away from the seat back 14 or in a first manner while retracting the head restraint assembly 16 may move the headrest 30 toward the seat back 14 or in a second manner. The electrical machine 80 may move or rotate in a first direction when the input signal is indicative of a command to advance and may move or rotate in a second direction that may be opposite the first direction when the input signal is indicative of a command to retract.

Operation of the electrical machine 80 may drive output element 82 which may then drive or rotate the intermediate unit 72. The intermediate unit 72 may then drive or rotate the output unit 74 which in turn actuates the support post 32. The interface between the actuator unit 70 and intermediate unit 72 and/or the interface between the intermediate unit 72 and output unit 74 may provide a resistive force or act as a locking mechanism that inhibits movement of the support post 32 when the electrical machine 80 is not operated. For instance, an interface having one or more gears may help inhibit movement in the absence of a sufficient actuation force. As such, the headrest 30 may be maintained in a desired position when the input signal is not indicative of an actuation command or during a vehicle impact event.

The actuation distance of the head restraint assembly 16 may be based on the configuration of the support post 32 and its engagement area 44. A longer engagement area 44 may provide a greater distance of travel. In at least one embodiment, the distance of travel may be around 50 mm, although a greater or lesser distance of travel.

Referring to FIG. 5, an example of an alternate embodiment of a drive assembly 38′ is shown. In this embodiment, an electrical machine 80′ may drive one or more output shafts or output elements. Although FIG. 5 shows multiple output shafts as well as a support post 32 having multiple upright portions 40, the present invention also contemplates embodiments having a single upright portion 40 and a single output shaft and associated components.

In FIG. 5, first and second output shafts 120, 122 are shown. The first and second output shafts 120, 122 may be provided as a single unitary structure. The first and second output shafts 120, 122 may be provided with first and second gears 124, 126, respectively, such as first and second spur or helical gears. The first and second gears 124, 126 may have different threads, such as left and right hand threads, in an embodiment in which the drive assembly 38′ rotates the first and second output shafts 120, 122 in common directions.

The first and second gears 124, 126 may engage a spur gear 130 that in turn engage the set of teeth 46 on the support post 32. The spur gear 130 may be rotatably mounted on a pin 132 that may be provided on a bracket or any suitable mounting surface.

Operation of the drive assembly 38′ may be similar to the embodiments previously discussed. An input signal may be provided to control operation of the electrical machine 80′. Operation of the electrical machine 80′ may rotate the output shafts 120, 122, which in turn rotate the spur gears 130 which in turn actuate the support post 32. The support post 32 may move in a first direction represented by the straight arrow line when at least one output shaft 120, 122 rotates in a first direction represented by the curved arrow lines, and may move in a second or opposite direction when at least one output shaft 120, 122 rotates in the opposite direction. The interface between one or more moveable components, such as the first and/or second gears 124, 126 and a respective spur gear 130 may provide a resistive force or act as a locking mechanism that inhibits movement of the support post 32 when the electrical machine 80′ is not operated. As such, the headrest may be maintained in a desired position as previously discussed.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A seat assembly comprising:
a seat back; and
a head restraint assembly associated with the seat back, the head restraint assembly including:
a headrest for supporting the head of a seat occupant;
a support post extending between the seat back and the headrest, the support post having an engagement area; and
a drive assembly having a rotatable element that engages the engagement area;
wherein the drive assembly actuates the headrest away from the seat back when the rotatable element is rotated in a first direction and actuates the headrest toward the seat back when the rotatable element is rotated in a second direction that is opposite the first direction.

2. The seat assembly of claim 1 wherein the engagement area extends from a distal end of the support post toward the headrest.

3. The seat assembly of claim 1 wherein the engagement area includes a set of teeth.

4. The seat assembly of claim 3 wherein the drive assembly includes a gear that engages the set of teeth.

5. The seat assembly of claim 4 further comprising an actuator that provides an actuation force for rotating the gear.

6. The seat assembly of claim 5 wherein the actuator includes an output shaft having an output shaft gear that engages the gear.

7. The seat assembly of claim 5 further comprising an intermediate unit that is driven by the actuator, wherein the intermediate unit engages a shaft upon which the gear is disposed.

8. A seat assembly comprising:
a seat back; and
a head restraint assembly disposed on the seat back, the head restraint assembly including:
a support post extending from the seat back and having an engagement area;
a headrest disposed on a support post and spaced apart from the engagement area;
an armature disposed in the seat back, the armature having a upright member that receives the support post, the upright member having an aperture disposed proximate the engagement area; and
a drive assembly that at least partially extends through the aperture to engage the engagement area;
wherein the drive assembly actuates the headrest toward and away from the seat back.

9. The seat assembly of claim 8 wherein the seat back has a frame and the armature is moveably disposed on the frame.

10. The seat assembly of claim 8 wherein the armature includes a lateral member disposed at an end of the upright member, wherein the lateral member is connected to a frame of the seat back and the support post extends through an opening in the lateral member.

11. The seat assembly of claim 10 wherein a guide member engages the support post and is disposed between the opening in the lateral member and the aperture.

12. The seat assembly of claim 8 further comprising a guide sleeve that is disposed on a frame of the seat back and engages an end of the upright member, wherein the support post extends through the guide sleeve and the upright member.

13. The seat assembly of claim 8 wherein the drive assembly further comprises a housing disposed on the armature.

14. A seat assembly comprising;
a seat back; and
a head restraint assembly disposed proximate the seat back, the head restraint assembly having:
a support post disposed on the seat back, the support post having an engagement area;
a headrest disposed on the support post; and
a drive assembly having:
an output unit that operatively engages the engagement area;
an intermediate unit that rotates to actuate the output unit; and
an actuator unit that rotates the intermediate unit;
wherein the headrest moves in a first direction when the intermediate unit rotates in a first rotational direction and moves in a second direction disposed opposite the first direction when the intermediate unite rotates in a second rotational direction.

15. The seat assembly of claim 14 wherein the intermediate unit provides gear reduction between the actuator unit and the output unit.

16. The seat assembly of claim 14 wherein the intermediate unit and the output unit cooperate to hold the headrest in a stationary position when the intermediate unit is not actuated by the actuator unit.

17. The seat assembly of claim 16 wherein the intermediate unit includes an output gear that engages an input gear on the output unit.

18. The seat assembly of claim 14 wherein engagement of the intermediate unit and the actuator unit holds the headrest in a stationary position when the intermediate unit is not actuated by the actuator unit.

19. The seat assembly of claim 18 wherein the actuator unit includes an output gear that engages an input gear on the intermediate unit.

20. The seat assembly of claim 14 further comprising a housing that at least partially receives the output unit, the intermediate unit, and the actuator unit.
